(19) United States
(12) Patent Application Publication
(10) Pub. No.: US 2008/0093020 A1
(43) Pub. Date: Apr. 24, 2008

(54) Rfid Applicator Roller Having Ic Relief And Rfid Applicator Incorporating Same

(75) Inventors: John C. Ford, Boca Raton, FL (US); Christopher Marcus, Simpsonville, SC (US)

Correspondence Address: IP LEGAL DEPARTMENT;TYCO FIRE & SECURITY SERVICES, ONE TOWN CENTER ROAD, BOCA RATON, FL, 33486, US

(73) Assignee: Sensormatic Electronics Corporation, Boca Raton, FL (US)

(21) Appl. No.: 11/660,247

(22) PCT Filed: Aug. 22, 2005
(86) PCT No.: PCT/US05/29810

§ 371 Date: Feb. 12, 2007

Related U.S. Application Data
(60) Provisional application No. 60/604,932, filed on Aug. 27, 2004.

(51) Int. Cl. B65C 9/08; B65C 1/04

(52) U.S. Cl. 156/324; 156/538

(57) ABSTRACT

A roller (300) for a radio frequency identification (RFID) label (102) applicator (100) and an RFID label applicator including the same. The roller includes an IC relief (328) for avoiding application of undue stress to the ICs of RFID labels carried on a web of material to items to which the labels are to be affixed.

### TECHNICAL FIELD

The invention relates to radio frequency identification (RFID) label applicators, and more particularly, to an RFID applicator roller having an IC relief and an RFID applicator incorporating the same.

### BACKGROUND INFORMATION

Radio frequency identification (RFID) systems are generally known and may be used for a number of applications such as managing inventory, electronic access control, security systems, automatic identification of cars on toll roads, and electronic article surveillance (EAS). RFID devices may be used to track or monitor the location and/or status of articles or items to which the RFID devices are applied. A RFID system typically includes a RFID reader and a RFID device such as a tag or label. The RFID reader may transmit a radio-frequency carrier signal to the RFID device. The RFID device may respond to the carrier signal with a data signal encoded with information stored on the RFID device. RFID devices may store information such as a unique identifier or Electronic Product Code (EPC) associated with an article or item.

RFID devices may be programmed (e.g., with the appropriate EPC) and applied to the article or item that is being tracked or monitored. A RFID reader/programmer may be used to program RFID devices and to detect defective RFID devices. Label applicators have been used to apply programmed RFID labels to items or articles.

Existing RFID applicators, however, can place excessive stress on the RFID labels as they are transferred through the applicator to the items to which they are to be attached. Generally, the RFID labels may be provided on a web of material wound around a feed roller. The web is drawn from the feed roller and directed by a series of driven and/or idler rollers to the RFD reader/programmer and, ultimately, to the location where the labels are removed from the web and applied to associated items. As the labels pass over/under the rollers, they are forced against and around the cylindrical exterior surface of the roller, causing stress and bending moments on the integrated circuit (IC) and antenna of the labels. In some cases, such stress can overcome the bond strength between the IC and the antenna, thereby damaging one or more of the RFID labels.

### SUMMARY OF THE INVENTION

The invention relates to an RFID applicator roller having an IC relief and an RFID applicator incorporating the same. Embodiments of the invention may include a radio frequency identification (RFID) label applicator having a web feeding mechanism for supplying a web of material carrying a plurality of RFID labels toward items to which the RFID labels are to be applied, the web feeding mechanism having at least one roller for directing the web of material toward the items, the at least one roller having a body having first and second end portions and a relief portion disposed between the first and second end portions, the relief portion having a smaller cross-sectional area than each of the end portions to define a relief area between the first and second end portions, the relief area being positioned for alignment with an integrated circuit (IC) associated with each of the RFID labels

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 is a diagrammatic view of a RFID applicator consistent with one embodiment of the invention.

FIG. 2 is a side cross-sectional view of one embodiment of a RFID label that can be used in the RFID applicator consistent with one embodiment of the invention.

FIG. 3 is a side view of one exemplary embodiment of a RFID applicator roller consistent with the invention.

FIG. 4 is a side view of the roller of FIG. 3 showing an IC of a RFID label on a web of material aligned with a relief area of the roller.

FIG. 5 is an exploded view of another exemplary embodiment of a RFID applicator roller consistent with the invention.

### DETAILED DESCRIPTION

Numerous specific details may be set forth herein to provide a thorough understanding of the embodiments of the disclosure. It will be understood by those skilled in the art, however, that various embodiments of the disclosure may be practiced without these specific details. In other instances, well-known methods, procedures, components and circuits have not been described in detail so as not to obscure the various embodiments of the disclosure. It can be appreciated that the specific structural and functional details disclosed herein are representative and do not necessarily limit the scope of the disclosure.

It is worthy to note that any reference in the specification to “one embodiment” or “an embodiment” according to the present disclosure means that a particular feature, structure, or characteristic described in connection with the embodiment is included in at least one embodiment. The appearances of the phrase “in one embodiment” in various places in the specification are not necessarily all referring to the same embodiment.

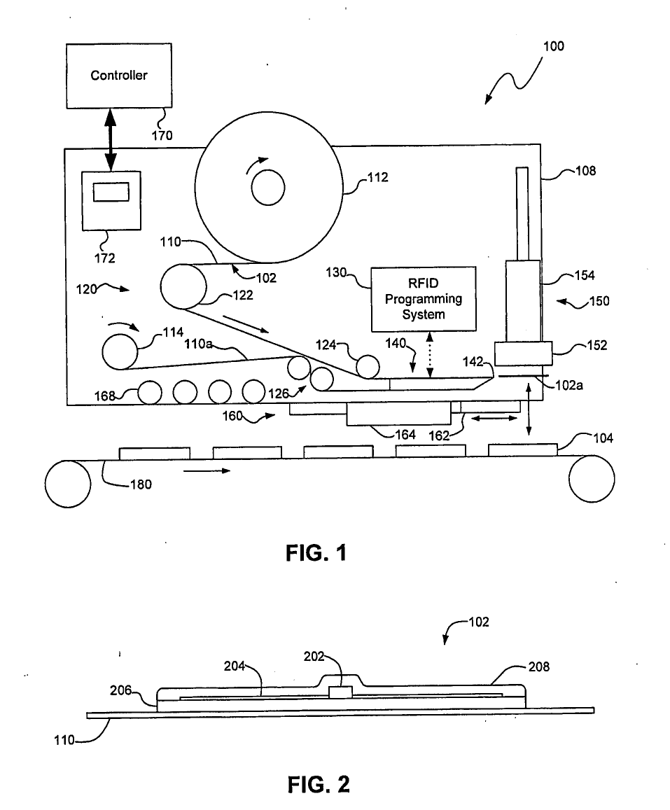

Referring to FIG. 1, radio frequency identification (RFID) label applicator 100, consistent with embodiments of the invention, may be used to apply RFID labels 102 to articles or items 104. The RFID label applicator 100 may also be used to program RFID labels 102, to detect defective RFID labels, and to reject the defective labels such that the defective labels are not applied to the items 104. The articles or items 104 may be products, merchandise, or any other items or articles that may be monitored using RFID techniques.

The RFID labels 102 may be removably secured to a backing material or web 110 such that the RFID labels 102 are supported on the web 110 during programming and may be removed (e.g., peeled away from the web 110) for application. The web 110 supporting the labels 102 may be rolled onto a roll 112, which is unwound to allow the web 110 to pass through the label applicator 100. After the REID labels 102 are removed or rejected, scrap web 110a may be rewound onto a rewind roll 114.

One embodiment of the RFID label applicator 100 may include a web feeding mechanism 120 to feed the web 110, a RFID programming system 130 to program the RFID labels 102, a peeler member 140 to peel the RFID labels 102 from the web 110, a label tamp assembly 150 to apply the RFID labels 102 to the items 104, and a label reject assembly 160 to reject RFID labels. The RFID) label applicator 100 may also include an applicator controller 170 to control operation of the RFID label applicator 100. The articles or items 104 may be arranged in a line (e.g., a product line) and may be moved, for example, using a conveyor 180 or other similar mechanism. Components in the applicator 100 may be mounted or secured to an applicator frame 108.

The RFID label applicator 100 may also include other components not shown in FIG. 1. Examples of additional components include, but are not limited to, a label sensor to sense and position the labels 102 relative to the RFID programming system 130, an item sensor to sense and position the items 104 relative to the tamp assembly 150, and an integrated printer to print indicia on the labels 102. One example of a label sensor includes a retroreflective that shines a light from beneath the web to a light sensor 110 positioned above the web 110.

The web feeding mechanism 120 may include at least one tensioning roller 122 and at least one idler roller 124, which guide the web 110 with the RFID labels 102 to the peeler member 140. The web feeding mechanism 120 may also include a drive and nip roller assembly 126 that takes up the scrap web 110a and feeds the scrap web 110a to the web rewind roll 114. The drive and nip roller assembly 126 may be driven to pull the scrap web 110a, thereby causing the web 110 with the RFID labels 102 to pass around the peeler member 140. The unwind roll 112 and/or rewind roll 114 may also be driven (e.g., with servomotors) to facilitate unwinding of the web 110 and/or rewinding the scrap web 110a.

The RFID programming system 130 may include a RFID reader/programmer coupled to one or more RFID programming antennas. The RFID programming system 130 may include any RFID reader/programmer known to those of ordinary skill in the art for reading and/or programming RFID devices, such as the type known as the Sensormatic® SensorID™ Agile 2 Reader available from Tyco Fire and Security. The RFID programming system 130 may also be capable of detecting defective RFID labels, for example, by attempting to read a RFID label after applying programming signals.

The peeler member 140 may include a peel tip 142 having a radius and forming an angle such that a RFID label 102 peels away from the web 110 as the web 110 passes around the peel tip 142. In one embodiment, the radius of the peel tip 142 may be in a range of about 0.003 in. and the angle formed by the peel tip 142 may be in a range of about 90° or less. Other radii and angles may be used and may depend upon the adhesion properties (e.g., the adhesion strength) of the RFID labels 102 on the web 110. The peeler member 140 may be made of a rigid material such as aluminum. In one embodiment, the peeler member 140 may be in the form of a plate or a bar, although those skilled in the art will recognize other shapes and configurations.

The label tamp assembly 150 may include a tamp pad 152 coupled to a tamp driving mechanism 154. The tamp pad 152 contacts the non-adhering side of a RFID label 102a that has been removed from the web 110 and holds the RFID label 102a. The tamp driving mechanism 154 drives the tamp pad 152 and the RFD label 102a toward the item 104 to which the RFID label 102a is to be applied. One embodiment of the tamp assembly 150 uses a vacuum pressure to retain the RFD label 102a in contact with the tamp pad 152. The vacuum pressure may be released and/or air may be blown from the tamp pad 152 to facilitate application of the RFID label 102a. Although the exemplary embodiment shows one embodiment of a label tamp assembly 150, the label tamp assembly 150 may include any structure or mechanism for moving a label into contact with an item 104.

The label reject assembly 160 may include an accumulation pad 162 coupled to a label reject driving mechanism 164. Upon determining that a RFID label 102 is to be rejected, the reject driving mechanism 164 drives the accumulation pad 162 into the path of the tamp pad 152. The tamp pad 152 then applies the rejected RFD label to the accumulation pad 162 instead of the item 104. A RFID label may be rejected when the label is determined to be defective or for other reasons. Although the exemplary embodiment shows one embodiment of the label reject assembly 160, the label reject assembly 160 may include any structure for intercepting or otherwise preventing a RFID label from being applied to an item 104.

The tamp driving mechanism 154 and the label reject driving mechanism 164 may include pneumatic actuated air cylinders, such as the type available from PHD, Inc. When air cylinders are used as the driving mechanisms, the RFID label applicator 100 may also include one or more air pressure gauges 168 to monitor and/or adjust operation of the air cylinders, as is known to those skilled in the art. Although the exemplary embodiment uses air cylinders and rods, those skilled in the art will recognize that other linear actuators or driving mechanisms may be used.

The applicator controller 170 may be a programmable logic controller (PLC), such as the type available from Allen-Bradley, Omron or Mitsubishi, or a general purpose computer, such as a PC, programmed to control one or more operations of the applicator 100. The controller 170 may be coupled to the web feeding mechanism 120 (e.g., to the motors, sensors, etc.) to control the feeding of the web 110 around the peeler member 140 and/or to control the positioning of the RFID labels 102 relative to the RFID programming system 130. The controller 170 may also be coupled to the tamp assembly 150 to control application (or tamping) of programmed and removed RFID labels to the items 104. The controller 170 may also be coupled to the label reject assembly 160 to control the rejection of labels, for example, when the label is determined to be defective. The controller 170 may also be coupled to a user interface/control panel 172 to enable a user to monitor the application process and/or to provide commands and/or operating parameters to the controller 170.

The controller 170 and/or user interface 172 may also be coupled to the RFID programming system 130 to control the RFID programming operations. RFD programming operations may be controlled, for example, by allocating Electronic Product Codes (EPC's) and/or other data to be sent to the RFID labels 102 upon receiving an indication that the RFID labels 102 are properly positioned relative to the RFID programming system 130. The controller 170 may also monitor the detection of defective labels to control the label reject assembly 160. The controller 170 may further collect programming data and statistics and provide such data to the user.

According to one method of operation, the web 110 may be advanced around the peeler member 140, for example, by using the drive and nip roller assembly 126 to pull the web 110. As the web 110 is advanced, the unwind roll 112 unwinds the web 110 supporting the RFID labels 102 and the rewind roll 114 rewinds the scrap web 110a after the RFID labels 102 have been applied or rejected. When each RFID label 102 on the web 110 is positioned within a programming range of the REID programming system 130, the RFID programming system 130 may program the RFID label 102 by transmitting radio frequency (RF) programming signals to the RFID label 102 and attempting to read the RFID label 102. The RFID label 102 may then be advanced around the peel tip 142 of the peeler member 140 to remove the RFID label 102. A removed RFID label 102a may then be applied to an item 104 using the tamp assembly 150 or may be rejected using the label reject assembly 160. These operations may be repeated for each of the RFID labels 102 on the web 10 and the items 104 may be advanced such that programmed RFID labels 102 are applied to each of the items 104.

One embodiment of a RFID label 102 is shown in greater detail in FIG. 2. The RFID label 102 may include an integrated circuit (IC) chip 202 coupled to an antenna 204. The IC chip 202 and antenna 204 may be sandwiched between one or more layers or substrates, such as an adhesive substrate 206 and a printable layer 208. The adhesive substrate 206 may include a scrim coated on each side with an adhesive, such as an acrylic based adhesive. The printable layer 208 may be made of a thermal transfer paper or other material suitable for printing. One or more additional layers or substrates may also be incorporated into the RFID label 102, as is known to those skilled in the art. The web 110 may be made of a paper with a release agent such as wax or silicone to allow the RFID label 102 to peel away from the web 110. The RFID label 102 may have a peel adhesion strength (e.g., about 15 N/inch) that allows the RFID) label 102 to be removably adhered to the web 110 and later adhered to the items 104. Although RFID labels may have various sizes, one example of the RFID label 102 may be about 3 in. by 3 in. and supported on a web 110 having a width of about 4 in.

One example of a RFID label 102 is the “Combo EAS/RFID Label or Tag” disclosed in U.S. Provisional Patent Application Ser. No. 60/628,303, which is fully incorporated herein by reference. Other examples include the RFID labels commercially available under the name Sensormatic® from Tyco Fire and Security. Those skilled in the art will recognize that the RFID label 102 may include any RFID device capable of being adhered or otherwise secured to articles or items.

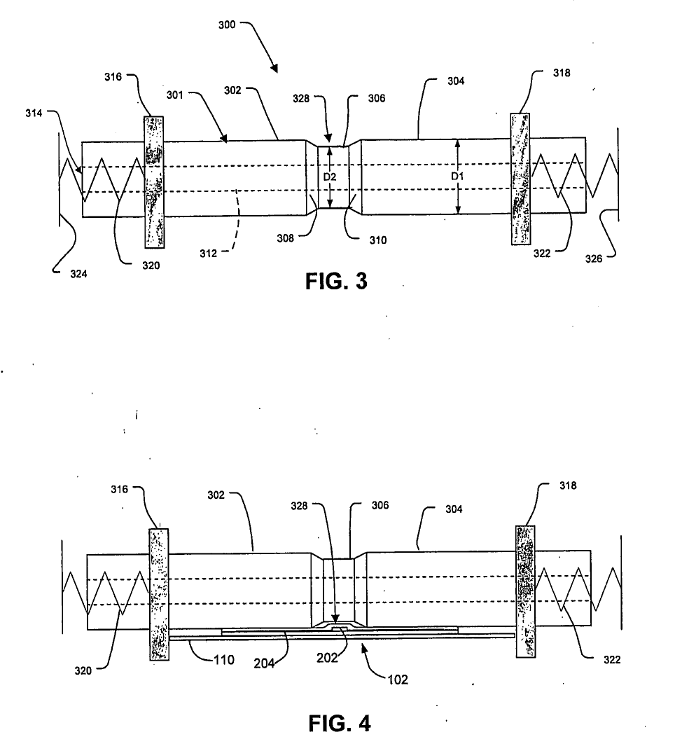

Referring to FIG. 3, one embodiment of an RFD applicator roller 300 consistent with the invention is shown in greater detail. As shown, the roller 300 generally includes a body 301 having an exterior surface defined by first 302 and second 304 end portions separated by at least one relief portion 306 and an interior surface 312 defining an opening 314 extending axially through the body 301. The opening 314 may be dimensioned for receiving an axle (not shown) for rotatingly supporting the body 301 as a web of RFID labels passes by the roller in contact with a top or bottom thereof.

In the illustrated exemplary embodiment, the end portions 302, 304 are generally cylindrical having a first diameter D1. The relief portion 306 is also generally cylindrical having a diameter D2, which is less than D1. The end portions 302, 304 and the relief portion 306 may be separated by associated beveled transition surfaces 308, 310. Due to the difference in diameter between the end portions 302, 304 and the relief portion 306, the cross-sectional area of each of the end portions 302, 304 is greater than the cross-sectional area of the relief portion 306. It is to be understood that although the end portions 302, 306 and relief portions 306 are cylindrical in the illustrated exemplary embodiment, the end and/or relief portions may have a non-cylindrical configuration with the cross-sectional area of the end portions being greater than the cross-sectional area of the relief portion.

The dimensional difference between the end portions 302, 304 and the relief portion 306 establishes a relief area 328 between the end portions 302, 304. As illustrated in FIG. 3, the relief area 328 of the roller may be positioned to align with the IC 202 of an RFID label 102 in an applicator system to protect the IC chip 202 from stresses as it passes by the roller 300. In an embodiment where the web passes under the roller, as shown in FIG. 3, opposite ends of the RFID label 102 may contact the first 302 and second 304 end portions while the IC 202 is disposed in or below the relief area 328. In an application where the web passes over the roller (not shown) the web 110 may contact the first 302 and second 304 end portions with the IC aligned with and disposed above the relief area 328. In either embodiment, the relief area 328 reduces stress on the IC as the web 110 is directed by the roller 300 to the articles to which the label 102 is to be applied.

In one embodiment, the relief area 328 may have a depth, measured from the exterior surface of the end portions 302, 304 to the exterior surface of the relief portion 306, of about 0.030″ and a width, measured from the intersection of the transition surface 308 with the relief portion 306 to the intersection of the transition surface 310 with the relief portion 306, of about 0.5″. Of course, the dimensions of the relief area 328 may be modified as desired to accommodate the dimensions of the RFID label 102 and to ensure that destructive stresses applied to the IC 202 of the label are minimized.

In the illustrated exemplary embodiment, first 316 and second 318 web guides are disposed about the first 302 and second 304 end portions, respectively, for centering the web so that the label ICs remain aligned with the relief area 328 as they pass by the roller. In one exemplary embodiment, each of the web guides 316, 318 may include a central opening through which its associated end portion 302, 304, respectively, may pass. The body 301 may be rotatably supported on an axle for rotation relative to the web guides 316, 318, or the web guides 316, 318 may be coupled to the end portions 302, 304, respectively, for rotation therewith.

A spring 320,322 may be disposed between each of the web guides 316, 318, respectively, and a fixed structure 324, 326. The springs 320,322 may be configured to urge the web guides 316, 318 inward along the end portions 302, 304 toward the relief portion 306 and against the edges of the web, e.g. web 110. Different web widths may be accommodated by simply forcing the web guides 316, 318 apart, against the bias of the springs 320,322, to receive the width of the web. Once a desired width is established, the web guides 316, 318 may be locked into position relative to the body 301 using any known releasable or removable locking mechanism, such as a set screw, spring biased detent, etc.

Alternatively, the web guides 316, 318 may be adjustably positionable along the lengths of the end portions 302, 304 to accommodate webs of different widths using the same roller. Once the web guides 316, 318 are moved to desired positions, a releasable or removable locking mechanism may be applied to lock them into position relative to the body. Although the web guides are described herein as being disposed circumferentially around the end portion, it is to be understood that the web guides 316, 318 may extend around only a portion of the circumference of the end portions 302, 304. Also, the web guides 316, 318 may take any geometric shape and need only extend radially beyond the exterior surface of the end portions 302, 304 for guiding the web and aligning the IC with the relief area 328.

A roller 300 consistent with the invention may be used at any location in an RFID applicator system where it is useful or necessary to pas a web carrying RFID labels over a roller, e.g. as a tensioning roller 122 or idler roller 124. In one embodiment the roller may have a diameter D1 of about 3.0″ at the end portions 302, 304 and a diameter D2 of about 2.97″ at the relief portion 306. The roller may be constructed from any material of sufficient strength and rigidity to withstand stresses associated with guiding a web of RFID labels in a RFID label applicator, including materials such as, aluminum, steel, etc.

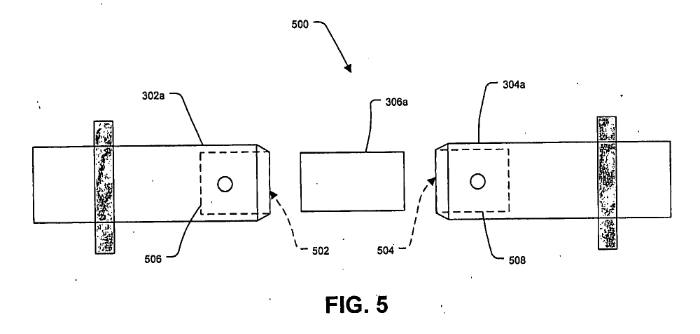

The roller body 301 including the end portions 302, 304 and the relief portion 306 may be constructed as a unitary member by machining from a single piece of material, and the web guides 316, 318 may be separately added. Alternatively, the roller may be constructed from multiple separate parts. Turning to FIG. 5, for example, there is illustrated another embodiment 500 consistent with the invention. The roller 500 includes first 302a and second 304a separate end pieces including openings 502, 504, respectively, at the ends thereof for receiving a separate relief portion 306a. One end of the relief portion 306a may be inserted into one of the openings 502, 504, and the other end of the relief portion 306a may be inserted into the other of the openings 502, 504. The ends of the relief portion 306a may be secured within the openings 502, 504 using any known releasable or removable locking mechanism, such as a set screw inserted through threaded openings 506, 508, a spring biased detent, etc. The width of the relief area may be adjusted in such a configuration by selection of the depth of insertion of the relief portion 306a into openings 502, 504. This allows the roller to be configured for operation with RFID label configurations of different dimensions and/or orientations.

There is thus provided, according to one aspect of the invention, a radio frequency identification (RFID) label applicator including a web feeding mechanism for supplying a web of material carrying a plurality of RFID labels toward items to which the RFID labels are to be applied. The web feeding mechanism includes at least one roller for directing the web of material toward the items. The roller includes a body having first and second end portions and a relief portion disposed between the first and second end portions. The relief portion has a smaller cross-sectional area than each of the end portions to define a relief area between the first and second end portions. The relief area is positioned for alignment with an integrated circuit (IC) associated with each of the RFID labels.

According to another aspect of the invention, there is provided a method of guiding a web of material carrying a plurality of RFID labels in an RFID label applicator for applying the RFID) labels to associated items. The method includes directing the web of material toward the associated items using at least one roller. The roller includes a relief area aligned with an integrated circuit (IC) associated with each of the RFID labels as the RFID labels pass by the roller.

According to another aspect of the invention, there is provided a roller for directing a web of material carrying a plurality of RFID labels toward items to which the RFID labels are to be applied. The roller includes a body having first and second end portions and a relief portion disposed between the first and second end portions. The relief portion has a smaller cross-sectional area than each of the end portions to define a relief area between the first and second end portions for alignment with an integrated circuit (IC) associated with each of the RFID labels.

Those of ordinary skill in the art will recognize other multiple piece configurations that will allow adjustment of the width of the relief area. For example, a combined end portion and relief portion may be formed as a single unit and the opposite end portion may have an opening for receiving the relief portion to a selected depth of insertion. In addition, a separate relief portion may be provided with ends dimensioned to be received within associated ends of the end portions, and with middle section dimensioned to achieve a desired depth or shape of the relief area.

While the principles of the invention have been described herein, it is to be understood by those skilled in the art that this description is made only by way of example and not as a limitation as to the scope of the invention. Other embodiments are contemplated within the scope of the invention in addition to the exemplary embodiments shown and described herein. Modifications and substitutions by one of ordinary skill in the art are considered to be within the scope of the invention, which is not to be limited except by the following claims.

What is claimed is:

1. A radio frequency identification (RFID) label applicator comprising:
a web feeding mechanism for supplying a web of material carrying a plurality of RFID labels toward items to which said RFID labels are to be applied, said web feeding mechanism comprising at least one roller for directing said web of material toward said items, said at least one roller comprising a body comprising first and second end portions and a relief portion disposed between said first and second end portions, said relief portion having a smaller cross-sectional area than each of said end portions to define a relief area between said first and second end portions, said relief area being positioned for alignment with an integrated circuit (IC) associated with each of said REID labels.

2. A RFID label applicator according to claim 1 wherein said roller further comprises first and second web guides disposed at least partially about said first and second end portions, respectively, for engaging said web of material to align said ICs with said relief area.

3. A RFID label applicator according to claim 2 wherein roller comprises a first spring for urging said first web guide toward said relief portion and a second spring for urging said second web guide toward said relief portion.

4. A RFID label applicator according to claim 1 wherein said first and second end portions and said relief portion have a generally cylindrical shape.

5. A RFD label applicator according to claim 1 wherein said body comprises a unitary member including said first and second end portions and said relief portion.

6. A RFID label applicator according to claim 1 wherein at least one of said end portions is positionable relative to said relief portion for allowing adjustment of a width of said relief area.

7. A RFID label applicator according to claim 1 wherein at least one of said end portions is configured for receiving an end of said relief portion at a selectable depth of insertion for allowing adjustment of a width of said relief area.

8. A RFID label applicator according to claim 1 wherein each of said end portions is configured for receiving an associated end of said relief portion at a selectable depth of insertion for allowing adjustment of a width of said relief area.

9. A RFID label applicator according to claim 1 wherein said body further comprises a first beveled transition surface between said first end portion and said relief portion and a second beveled transition surface between said second end portion and said relief portion.

10. A method of guiding a web of material carrying a plurality of RFID labels in an RFID label applicator for applying the RFD labels to associated items, said method comprising:
directing said web of material toward said associated items using at least one roller, said at least one roller comprising a relief area, said relief area being aligned with an integrated circuit (IC) associated with each of said RFID labels as said RFID labels pass by said roller.

11. A method according to claim 10 wherein said roller comprises first and second end portions and a relief portion disposed between said first and second end portions, said relief portion having a smaller cross-sectional area than each of said end portions to define said relief area between said first and second end portions.

12. A method according to claim 11 wherein said roller further comprises first and second web guides disposed at least partially about said first and second end portions, respectively, for engaging said web of material to align said ICs with said relief area.

13. A method according to claim 12 wherein roller comprises a first spring for urging said first web guide toward said relief portion and a second spring for urging said second web guide toward said relief portion.

14. A method according to claim 11 wherein said first and second end portions and said relief portion have a generally cylindrical shape.

15. A method according to claim 11 wherein said body comprises a unitary member including said first and second end portions and said relief portion.

16. A method according to claim 11 wherein at least one of said end portions is positionable relative to said relief portion for allowing adjustment of a width of said relief area.

17. A method according to claim 11 wherein at least one of said end portions is configured for receiving an end of said relief portion at a selectable depth of insertion for allowing adjustment of a width of said relief area.

18. A method according to claim 11 wherein each of said end portions is configured for receiving an associated end of said relief portion at a selectable depth of insertion for allowing adjustment of a width of said relief area.

19. A method according to claim 11 wherein said body further comprises a first beveled transition surface between said first end portion and said relief portion and a second beveled transition surface between said second end portion and said relief portion.

20. A roller for directing a web of material carrying a plurality of RFID labels toward items to which said RFID labels are to be applied, said roller comprising:
a body having first and second end portions and a relief portion disposed between said first and second end portions, said relief portion having a smaller cross-sectional area than each of said end portions to define a relief area between said first and second end portions for alignment with an integrated circuit (IC) associated with each of said RFID labels.
